(19) United States
(12) Patent Application Publication
(10) Pub. No.: US 2018/0093593 A1
(43) Pub. Date: Apr. 5, 2018

(54) DEVICE FOR DAMPING PRESSURE FLUCTUATIONS

(71) Applicant: Conti Temic Microelectronic GmbH, Nuernberg (DE)

(72) Inventors: Michael BEUSCHEL, Stammham (DE); Bernhard HUMPERT, Pfaffenhofen (DE); Johann RIEPL, Denkendorf (DE); Michael SCHNELL, Ingolstadt (DE)

(21) Appl. No.: 15/563,831

(22) PCT Filed: Mar. 16, 2016
(86) PCT No.: PCT/EP2016/055634

§ 371 Date: Oct. 2, 2017

(30) Foreign Application Priority Data
Apr. 2, 2015 (DE) 10 2015 206 092.6

(51) Int. Cl. B60N 2/44; F04C 29/06; F04C 29/00; F04B 11/00; F04B 39/00; F04C 18/344

(52) U.S. Cl. CPC B60N 2/4415; F04C 29/065; F04C 18/344; F04B 11/0008; F04B 39/0055; F04C 29/0035

(57) ABSTRACT

A device (DV) for damping pressure fluctuations in a pressure medium (DM) comprises the following features. It has a base body (GK) in which an intake chamber (AK11) is provided, which has an intake-chamber opening (OA1) which is located at a first side (S1) of the base body. A first expansion chamber (EK11) is furthermore provided in the base body, which has a first expansion-chamber opening (OE1), which is likewise located at the first side of the base body. A partition wall (T1) separates the intake chamber from the first expansion chamber. A cover element (AD) for positioning on a contact surface (AF) of the first side of the base body is furthermore provided in order to close the intake chamber and the first expansion chamber to the outside. Finally, an overflow channel is provided, in particular in the partition wall between the intake chamber and the first expansion chamber, so that pressure fluctuations in the pressure medium are damped during the through-flow from the intake chamber through the first overflow channel into the first expansion chamber.

The present invention relates to a device for damping pressure fluctuations occurring in a pressure medium, in particular for a pressure-medium pump. The invention furthermore relates to a pressure-medium pump, in particular for a pneumatic adjusting arrangement of a vehicle seat.

In modern vehicle seats, bladders which can be filled with a pressure medium, in particular with compressed air, are arranged as actuating elements in a region of the seat surface or seat back (together referred to as a seat contact surface) and can be supplied with pressure medium via a respective pressure-medium line. As a result of filling a respective bladder with pressure medium, its volume is increased so that the properties of the seat back or seat surface can be altered with regard to the contour. In addition to a static adjustment of the contour of a seat back or seat surface, for example within the context of a lumbar support, this also enables massage functions for an occupant of the vehicle seat through regular or dynamic alteration of the contour of the seat back or seat surface. To fill a bladder with pressure medium, this latter is firstly generated by a pressure-medium source, for example a compressor, and guided to a respective bladder via a corresponding valve, in particular an electropneumatic valve in a control device.

Pneumatic arrangements of this type, such as a pneumatic adjusting arrangement for a vehicle seat as mentioned above, are installed in the passenger area for comfort functions. It is important here that the noise level in the passenger area is low enough that the passengers or driver do not find the noises of the above-mentioned components, for example the pneumatic adjusting arrangement, annoying. As mentioned above, a compressor, which can operate according to the displacement principle, such as a piston, diaphragm or valve type compressor, is used for generating a pressure medium in an adjusting arrangement for a vehicle seat. Depending on the design, a compressor of this type generates the pressurized pressure medium with pulsations or pressure fluctuations. This generally results in unacceptable noise emissions in the passenger area for the passengers.

The object of the present invention, therefore, consists in reducing the noises generated by pressure fluctuations, in particular in the case of a pneumatic adjusting arrangement.

This object is achieved by the subject matter of the independent claims. Advantageous embodiments are the subject matter of the subclaims.

According to a first aspect of the invention, a device for damping pressure fluctuations in a pressure medium comprises the following features. It has a base body in which an intake chamber is provided, which has an intake-chamber opening which is located at a first side of the base body, and in which a first expansion chamber is provided, which has a first expansion-chamber opening, which is likewise located at the first side of the base body, wherein a first partition wall separates the intake chamber and the first expansion chamber from one another. The device furthermore has a cover element for positioning on a contact surface of the first side of the base body in order to close the intake chamber and the first expansion chamber. The device finally has a first overflow channel, which is provided between the intake chamber and the first expansion chamber so that pressure fluctuations in the pressure medium are damped during the through-flow from the intake chamber through the first overflow channel into the first expansion chamber. The overflow channel here is provided in particular in a region or portion between the partition wall and the cover element. By means of the proposed device, noises generated by pressure fluctuations are reduced, in particular for a pressure-medium pump of a pneumatic adjusting arrangement. The device can moreover be realized for damping pressure fluctuations with minimized device-related costs since it is only necessary to provide the structures for the intake chamber and the expansion chamber(s) in the base body, whilst a simple cover element, e.g. in the form of a planar plate (in the case of a planar contact surface), can be used for covering the respective chamber openings. The device-related costs of the device can moreover be further minimized in that a housing part of a pressure-medium pump to be connected to the device is used as the cover element. In such a case, the device can then be positioned or fastened on the pressure-medium pump by fastening means, for example screws, in such a way that the respective chamber openings of the device are closed by the housing part of the pressure-medium pump.

According to an embodiment of the device, the first overflow channel is formed in such a way that a portion of the partition wall between the intake chamber and the first expansion chamber has a predetermined spacing from the contact surface of the first side. Thus, all the essential functional structures are therefore incorporated in the base body so that the cover element can be formed as a simple part of the device.

According to a further embodiment of the device, the first overflow channel is formed in such a way that the cover element, in particular in the region of the partition wall between the intake chamber and the first expansion chamber, has a notch which extends from the intake chamber to the first expansion chamber. The functional structure for the overflow channel is therefore integrated in the cover element so that this latter has a further function here in addition to the closing property.

An overflow channel (both the first and also further overflow channels) can be designed in such a way that it has a diameter which widens from the intake chamber to the first expansion chamber (or from a first expansion chamber to a second expansion chamber). The overflow channel is thus created as an expansion element in which the flow energy is decreased during the through-flow and noises based on pressure fluctuations are therefore reduced.

According to a further embodiment of an overflow channel, this has a constant diameter. An overflow channel of this type is simple to produce with regard to the method and the device. It is also possible that an overflow channel has a diameter which initially tapers from the intake chamber to the first expansion chamber and then widens again. The tapering and subsequent widening again can be effected here by means of a rounded edge or even by way of a “sharp” edge (two channel faces converge at a particular angle).

According to a further embodiment, the device furthermore has a filter element for filtering out particles from the pressure medium, wherein the filter element is provided in particular in the intake chamber. It is thus ensured that particles which would otherwise lead to a blocking of pressure-medium lines, for example of a pressure-medium pump or a pneumatic arrangement, are already filtered away at the start during the intake process (i.e. upon entering a pneumatic arrangement).

According to a further embodiment of the device, the contact surface of the first side of the base body furthermore lies in a plane (in other words, is flat or planar in form), wherein the cover element has a planar portion which can be brought into contact with the contact surface. Both the contact surface and the planar portion can be machined here by grinding in order to optimize the respective planar structure. A simple construction of the base body and cover element is thus created, in which it is not necessary to undertake further sealing measures, in particular in the case of low pressure-medium pressures (or differences in pressure compared to the environment).

For improved sealing with regard to the pressure medium, a sealing element is provided between the cover element and the base body in the region of the contact surface. To this end, a groove can furthermore be provided in the base body or in the cover element in order to position and/or fix the sealing element there (e.g. as an elastomer). When the base body and/or the cover element is formed as an injection molded part, it is also conceivable that the base body and/or the cover element are formed as a multi-component injection molded part (e.g. 2K part) in which the sealing element is also injection molded. An elastomer film can also have been shaped, in particular punched, according to the contact surface of the base body and bonded to the base body and/or the cover element. It is furthermore possible to arrange the sealing element only in the outer circumferential region of the contact surface, wherein it is possible to save on the sealing element for example on portions of a partition wall between two chambers.

According to a further embodiment, the device furthermore has a second expansion chamber, which is provided in the base body and has a second expansion-chamber opening, which is likewise located at the first side of the base body. Furthermore, a second overflow channel is provided here, which is arranged between the first expansion chamber and the second expansion chamber so that pressure fluctuations in the pressure medium are further damped during the through-flow from the first expansion chamber through the second overflow channel into the second expansion chamber. It is moreover possible here for the cover element to furthermore also close the second expansion chamber when positioned on the contact surface of the first side of the base body. In addition to the second expansion chamber, it is also conceivable to generally provide a further (second, third, fourth etc.) expansion chamber with a corresponding overflow channel. The drop in pressure required for the desired damping is thereby split into several stages. The difference in pressure at the individual overflow channel is moreover lower, and larger throttle cross sections can be used for the individual overflow channels. This in turn results in lower flow speeds and lower noises at the overflow channels acting as throttle points. A high order low-pass filter is thus realized, which exhibits high damping, in particular for pulsation frequencies in the kHz range.

With reference to the second (further) expansion chamber, the device can furthermore have a second (further) partition wall, which separates the first expansion chamber and the second expansion chamber from one another, wherein the second overflow channel is formed in particular in such a way that a portion of the partition wall between the first expansion chamber and the second expansion chamber has a predetermined spacing from the contact surface of the first side. It is, of course, also conceivable for the cover element to have, in particular in the region of the second partition wall between the intake chamber and the first expansion chamber, a notch which extends from the first expansion chamber to the second expansion chamber. A respective design of an overflow channel can also be applied to expansion chambers which (as mentioned above) are connected downstream of the second expansion chamber and are separated from one another by respective partition walls.

According to a further embodiment of the device, the intake chamber has a pressure-medium inlet and the first expansion chamber or the second expansion chamber (or the last expansion chamber in the series) has a pressure-medium outlet. The pressure-medium inlet here can be arranged at a second side of the base body, whilst the pressure-medium outlet is arranged for example at the first side of the base body. Air, for example, can be taken in from the environment here as pressure medium via the pressure-medium inlet, whilst the air which is damped with regard to pressure fluctuations can be supplied for example to a pressure pump (in particular for a pneumatic arrangement) from the last expansion chamber in the series of expansion chambers.

According to a further embodiment of the device, at a delimitation of the intake chamber and/or the first expansion chamber and/or a further expansion chamber against which a pressure-medium flow strikes, an impact surface having a predetermined structure is provided in order to effect a deflection of the pressure-medium flow. An impact surface of this type can have a structure with depressions, elevations, cones, wedges and the like, which effects a deflection or diffuse distribution of the flow. Overflow channels are furthermore preferably arranged or aligned in such a way that a pressure-medium flow cannot travel from one overflow channel to a further overflow channel along a direct line. It is furthermore advantageous if overflow channels are arranged or aligned in such a way that the pressure-medium flow does not strike an inner delimitation or surface of an intake or expansion chamber substantially perpendicularly.

According to a further embodiment of the device, the intake chamber, the first expansion chamber and optionally a further expansion chamber form a first pressure-medium channel within the base body, wherein a second pressure-medium channel having an intake chamber and one or more subsequent expansion chambers can furthermore be provided in the base body. In particular, the second pressure-medium channel has the same construction as the first pressure-medium channel. If the device for damping pressure fluctuations is used in conjunction with a pressure-medium pump, the first pressure-medium channel can be seen as an intake channel for taking in pressure medium for the pressure-medium pump and the second pressure-medium channel can be seen as a pressure channel via which pressurized pressure medium is supplied for example to a pneumatic device. With minimized device-related costs, a damping of pressure fluctuations produced during the generation of the pressure medium, in particular by a pressure-medium pump or a compressor, is thus provided in a single component (of the device) both for an intake side and also for a pressure side, i.e. in two flow directions. The device for damping pressure fluctuations predominantly serves in particular for direct connection to a pressure-medium pump, so that, on the one hand, the pressure fluctuations or pulsations are damped or prevented directly at the site at which they are produced in order to also prevent possible amplification or exaggeration of the pulsations of components of a pneumatic arrangement which adjoin the device for damping pressure fluctuations. By damping the pressure fluctuations for two flow directions (during intake and pressure delivery) of the pressure medium in a single device, the installation space can furthermore be minimized.

According to a further aspect of the invention, a pressure-medium pump, in particular for a pneumatic arrangement, having the following features is created. It has an inlet for taking in pressure medium and an outlet for releasing pressurized pressure medium. It furthermore has a device for damping pressure fluctuations according to the description above, having a first pressure-medium channel (intake channel) and a second pressure-medium channel (pressure channel), wherein the first or optionally further expansion chambers of the first pressure-medium channel of the device is connected to the inlet, and the intake chamber of the second pressure-medium channel of the device is connected to the outlet. Since the second intake chamber is connected to the outlet of the pressure-medium pump when working together, it can also be referred to as a pressure chamber in such a case. In general, the terms intake channel and pressure channel are intended to indicate that, in particular when used with a pressure-medium pump, the intake channel of the device for damping pressure-medium fluctuations is connected to the inlet of the pressure-medium pump for taking in pressure medium and the pressure channel of the device is connected to the outlet of the pressure-medium pump for releasing pressurized pressure medium.

Advantageous embodiments of the device for damping pressure fluctuations in a pressure medium should, where applicable to the pressure-medium pump, also be regarded as advantageous embodiments of the pressure-medium pump, and vice versa.

Exemplary embodiments of the present invention shall now be explained in more detail below with reference to the accompanying drawings, in which:

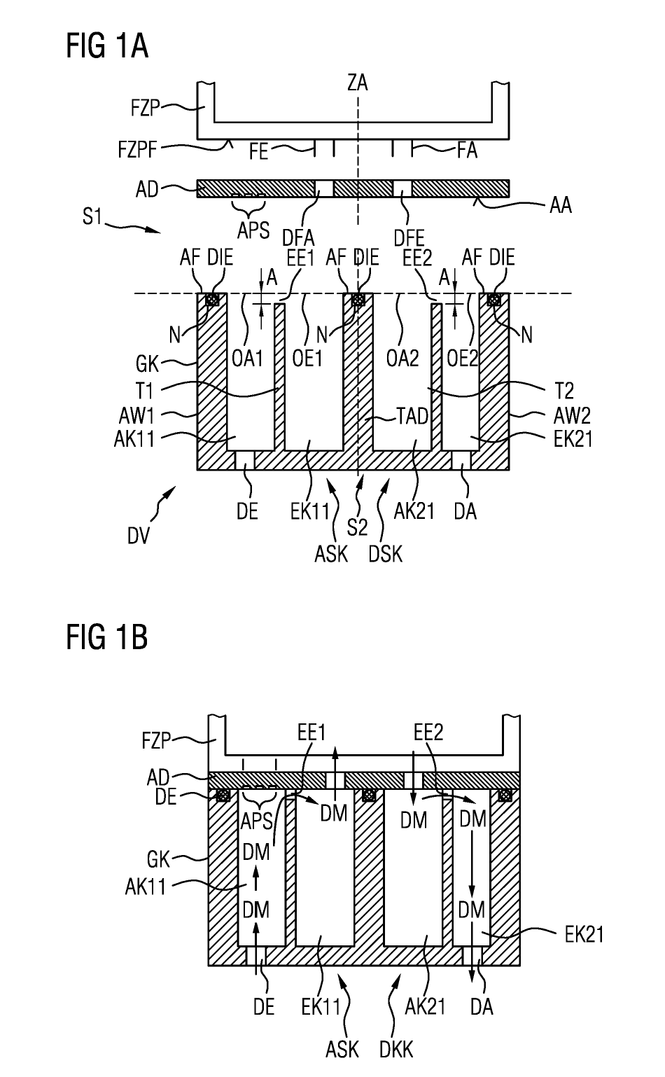

FIG. 1 shows a schematic sectional view of a device for damping pressure fluctuations in a pressure medium according to a first embodiment, wherein FIG. 1A shows an exploded illustration of the essential components, and FIG. 1B shows the device in the assembled state;

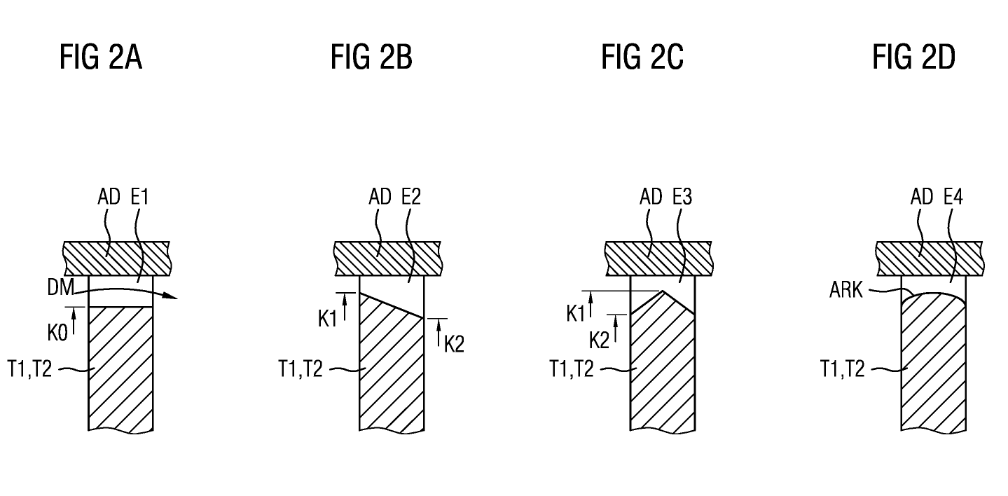

FIG. 2 shows respective schematic detailed views of a possible embodiment of an overflow channel;

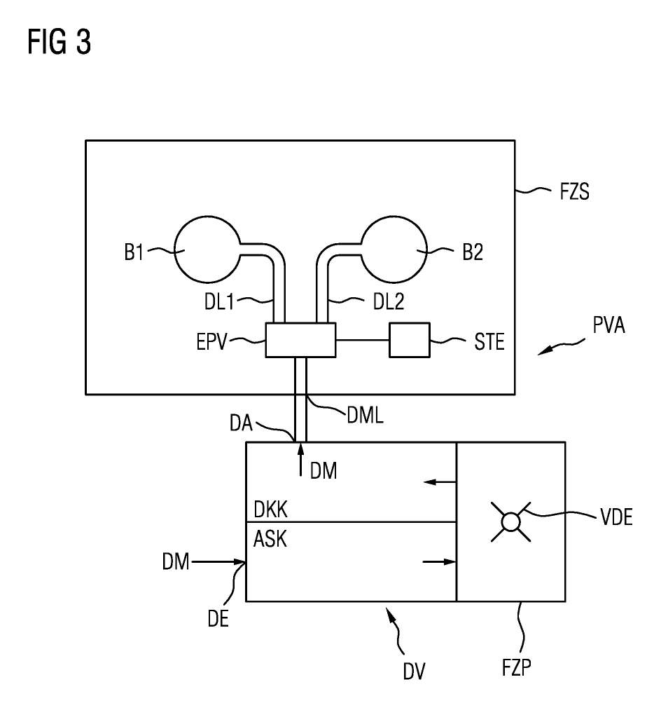

FIG. 3 shows a schematic illustration of a pneumatic adjusting arrangement with a device for damping pressure fluctuations;

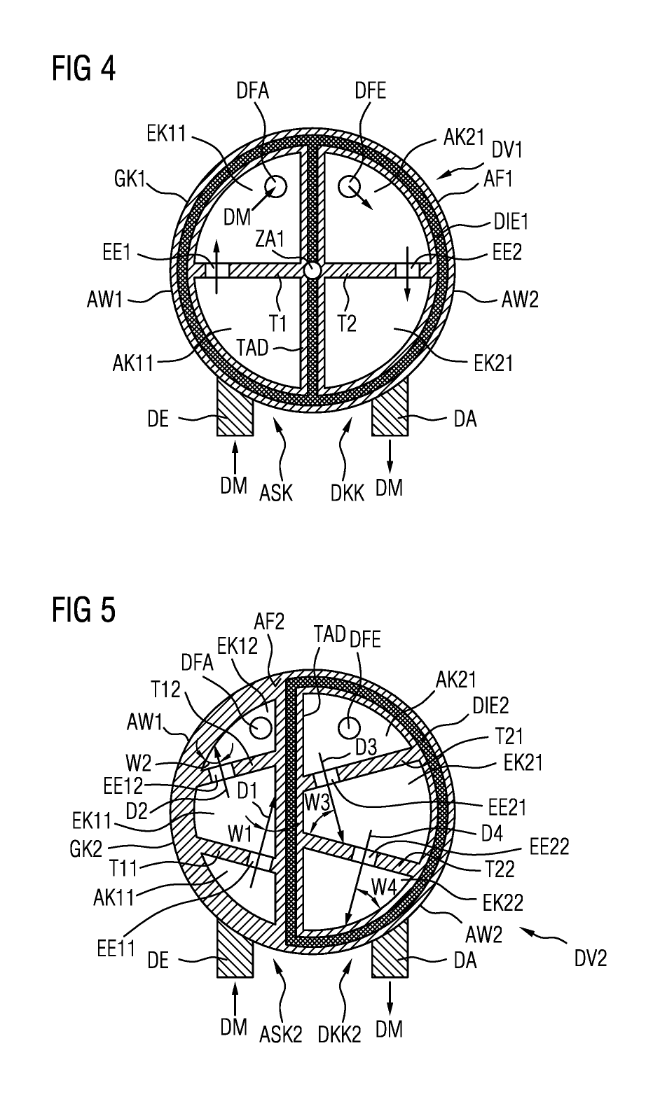

FIG. 4 shows a schematic plan view of a device for damping pressure fluctuations according to a second embodiment;

FIG. 5 shows a schematic plan view of a device for damping pressure fluctuations according to a third embodiment;

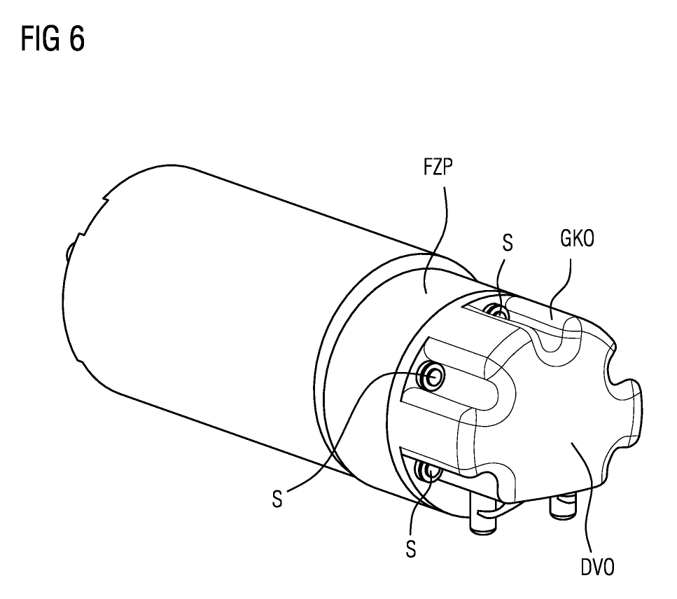

FIG. 6 shows a schematic illustration of a device for damping pressure fluctuations, viewed at an angle from front left, in a state in which the device is connected to a pressure-medium pump.

Reference is first of all made to FIG. 1, in which a device DV for damping pressure fluctuations in a pressure medium DM, in particular in the form of compressed air, is shown. As can furthermore be seen in FIG. 1, the device DV is in particular adapted to be connected directly to a pressure-medium pump FZP (c.f. also FIGS. 3 to 6 in this regard) in order to damp or prevent pressure fluctuations which occur predominantly during operation of the pressure-medium pump at the site at which they are produced.

The device DV here comprises a base body GK in which a first intake chamber AK11 is provided, which has a first intake-chamber opening OA1, which is located at a first side S1 of the base body GK. A first expansion chamber EK11 is furthermore provided in the base body, which expansion chamber has a first expansion-chamber opening OE1, which is likewise located at the first side S1 of the base body GK. The two chambers AK11 and EK11 are separated from one another by a first partition wall T1. At a second side S2 of the base body, an inlet opening DE is provided, through which pressure medium DM can flow into the first intake chamber AK1 from the environment, as shown by corresponding parts in FIG. 1B.

Looking now at the right-hand part of the base body GK in FIG. 1A, a second intake chamber AK21 is provided here in the base body, which intake chamber has a second intake opening OA2, which is located at the first side S1 of the base body. A second expansion chamber EK21 is furthermore provided, which has a second expansion-chamber opening OE2, which is likewise located at the first side S1 of the base body GK. A second partition wall T2 for separating the two chambers is provided between the second intake chamber AK21 and the second expansion chamber EK21. An outlet opening DA for a pressure medium is furthermore shown on the second side S2 of the base body, which pressure medium flows into the environment from the second expansion chamber EK21, as can also be seen in FIG. 1B.

A further partition wall TAD is provided between the first expansion chamber EK11 and the second intake chamber AK21, which partition wall separates the respective chambers from one another.

Reference is again made to the first side S1 of the base body GK. It can be seen here that grooves N, in which respective sealing elements DIE are located, are provided both on a first outer wall AW1 and a second outer wall AW2 of the base body GK and on the partition wall TAD. These sealing elements DIE serve to close the respective chambers AK11, EK11, AK21 and EK21 or the respective openings OA1, OE1, OA2 and OE2 in a pressure-medium-tight manner after the positioning of a cover element AD.

It can furthermore be seen at the first side S1 that the outer walls AW1 and AW2 as well as the partition wall TAD each have a contact surface AF, in the present case a planar contact surface, which lies in the plane E. At a predetermined spacing A from the plane E or from the contact surface AF, the respective upper portion of the partition wall T1 and the partition wall T2 is offset in the direction of the interior of the base body GK. As can be seen in FIG. 1B, this results in a clearance between the cover element AD and the respective partition walls T1 and T2 when the cover element AD is in position, so that a respective overflow channel for pressure medium is thus produced from the first intake chamber AK11 to the first expansion chamber EK11 and from the second intake chamber AK21 to the second expansion chamber EK21. As can be seen in FIG. 1B, pressure medium DM can thus flow from the first intake chamber via an overflow channel EE1 to the first expansion chamber EK11 so that pressure fluctuations in the pressure medium are damped during the through-flow through the respective overflow channels EE1 or EE2 as seen in the direction of the arrow. More precisely, the overflow channels in the device are arranged in such a way that they act from the respective intake chamber in the direction of the expansion chamber (or in the direction of a second expansion chamber), i.e. a pressure-medium flow coming from the intake chamber (or a first expansion chamber) expands and is therefore decreased with regard to its speed in the direction of the respective expansion chamber in order to thus damp the pressure fluctuations or pulsations.

As already mentioned, the device DV furthermore comprises a cover element AD which, as illustrated in FIG. 1A, has a planar portion AA at the underside, which can be brought into contact with the contact surface AA of the base body or the walls AW11, AW12, TAD thereof in order to create a pressure-medium-tight connection between the cover element AD and the base body GK (c.f. the illustration in FIG. 1B). The creation of planar portions here is possible in a simple manner, both with regard to the planar portion AA of the cover element AD and in the contact surfaces AF of the base body GK, and involves low costs with regard to the method and the device. For low pressure-medium pressures to be processed in the device, it can be sufficient here that it is sufficient to bring the planar portion AA into contact with the contact surface AF in order to create a pressure-medium-tight sealing of the chambers AK11, EK11, AK21, EK21 and in the base body with respect to the environment, without requiring the use of a special sealing element DIE. However, if higher pressures are to be processed, the use of sealing elements DIE such as that shown in FIG. 1 is advantageous.

As can furthermore be seen, the cover element AD comprises a pump-side outlet opening DFA via which, in the assembled state as shown in FIG. 1B, pressure medium DM can flow from the first expansion chamber EK11 in the direction of a pressure-medium pump FZP. The cover element AD furthermore has a pump-side inlet opening DFE which, in the assembled state, serves so that a pressure medium DM which is pressurized or compressed by the pressure-medium pump can flow from the pressure-medium pump FZP into the second intake chamber AK21.

Finally, a further impact surface APS having a predetermined structure is provided on the left-hand side of the cover element AD. The purpose of this impact surface here is that it effects a deflection of a pressure-medium flow, in particular it prevents the pressure-medium flow from possibly striking the impact surface perpendicularly, in order to thus deflect the pressure-medium flow specifically and therefore minimize the flow noise. It can be seen from the example of FIG. 1B that pressure medium DM taken in via the inlet opening DE would strike the impact surface APS of the cover element AD perpendicularly. Owing to the structure provided there, for example in the form of a stepped, wavy, burled structure or the like, (i.e. a structure having depressions, elevations, wedges, cones etc.), the pressure medium striking against the impact surface APS is deflected or broken in the manner of a breakwater at sea, as it were, so that a diffuse distribution of the flow and therefore a reduction in the level of the flow noises is achieved.

As can also be seen later with reference to FIG. 6, a pressure-medium pump FZP is brought directly into contact with or against the cover element AD to achieve a compact design, wherein a pressure-medium inlet FE of the pressure-medium pump cooperates with the pump-side outlet opening DFA here and a pressure-medium outlet FA of the pressure-medium pump cooperates or is fluidically interconnected with the inlet opening DFE of the cover element AD. The pressure-medium pump FZP can be for example a compressor, such as a vane type compressor.

Looking again at the assembled state of the device DV for damping pressure fluctuations with the pressure-medium pump FZP, as shown in FIG. 1B, it is possible to differentiate here between two pressure-medium channels. On the one hand, there is the intake channel ASK, in which pressure medium flows via the inlet opening DE, the first intake chamber AK11, the first overflow channel EE1, the first expansion chamber EK11 and the pump-side pressure-medium outlet opening DFA or the pressure-medium inlet FE to the pressure-medium pump FZP in order to be compressed there. In a pressure channel DKK, the pressure medium compressed by the pressure-medium pump FZP then flows via the pressure-medium outlet FA or the pump-side pressure-medium inlet opening DFE into the second intake chamber AK21, from there, via the second overflow channel EE2, into the second expansion chamber EK21 and finally, via the pressure-medium outlet opening DA, for example into a pneumatic adjusting device, as shown in FIG. 3.

Looking now at the base body GK in detail, this can have a hollow cylindrical form. The respective partition walls T1, TAD, T2 extend in the hollow cylinder here in such a way that they run parallel to a cylinder axis ZA. In the embodiment of FIG. 1, the chambers are all arranged adjacent to one another in a direction perpendicular to the cylinder axis ZA. This allows a small installation space and a small height along the cylinder axis ZA for the base body, in particular since the overflow channels in this construction are also aligned perpendicularly to the cylinder axis ZA.

It should be noted that it is also possible for the cover element AD (as an additional component) to also be omitted. The pressure-medium pump FZP could then assume the function of the cover element. More precisely, a front surface of the pump FZPF which, as shown in FIG. 1A, normally comes into contact with the cover element when the base body GK with the cover element AD and the pressure-medium pump are put together (c.f. FIG. 1B), could then assume the function of the cover element as a cover surface. In this case, it would be possible here for the pressure-medium inlet FE and the pressure-medium outlet FA to be formed not as protruding inlets or outlets, but flush with the cover surface. It would then also be conceivable to provide corresponding structures APS for deflecting a pressure-medium flow at the cover surface.

Reference is now made to FIG. 2, in which a schematic detailed view of the overflow channels E1, E2, E3 and E4 is shown. It is conceivable here that the overflow channels EE1 and EE2 of the embodiments in FIG. 1 or even the overflow channels of the embodiments in FIGS. 4 and 5 can be formed according to one of the variants E1, E2, E3 or E4. The common factor in all four variants in FIGS. 2A-2D is the fact that the overflow channels E1-E4 are formed in that a respective partition wall T1 or T2 or a portion thereof have a predetermined (also varying) spacing from the contact surface AF or from the cover element AD in order to form the channel.

Looking now at FIG. 2A, it can be seen that a constant spacing K0 remains here between a respective partition wall T1 or T2 and the cover element AD, so that the diameter of the overflow channel E1 for the pressure medium DM is also constant.

Looking at FIG. 2B, it can be seen that, as viewed from left to right, a spacing K1 between a respective partition wall T1 or T2 and the cover element AD increases up to a spacing K2 (K2 is greater than K1). The overflow channel E2 therefore has a widening diameter. This means that, as a result of this diameter or cross-sectional increase, for a pressure medium flowing from left (from an intake chamber) to right (to an expansion chamber), the speed of the pressure medium, and therefore pressure fluctuations or pulsations in the pressure medium, is decreased. In the event that the pressure medium contains particles whereof the dimensions are greater than the spacing K1, these particles will be unable to enter the overflow channel E2 and are also unable to block it.

Looking now at FIG. 2C, it can be seen that an initially large spacing K2 between a partition wall T1 or T2 and the cover element AD decreases to a smaller spacing K1 and then widens again. Such a diameter of the overflow channel E3, which initially tapers and then widens again, likewise effects a decrease in the flow speed and likewise a reduction in the turbulent flow.

A further reduction in the turbulent flow is achieved in that, as shown in FIG. 2D, a convex rounding of a partition wall T1 or T2 in relation to the cover element AD is proposed. In the overflow channel E4 here, the diameter again initially tapers and will widen again by means of rounded edges ARK.

Reference is now made to FIG. 3, in which a schematic illustration of a pneumatic adjusting arrangement PVA is shown. As a pressure-medium source, this pneumatic adjusting arrangement PVA comprises a pressure-medium pump FZP (for example in the form of a vane type pump), which is connected to a device DV for damping pressure fluctuations. The device DV here can be formed according to the device DV according to FIG. 1. It is, of course, also conceivable that the device for damping pressure-medium fluctuations is formed according to the further embodiments in FIGS. 4 and 5.

As shown on the bottom left in FIG. 3, pressure medium DM flows through an inlet opening DE of the device DV here into the corresponding intake channel ASK (c.f. also FIG. 1), is damped with regard to any possible pressure fluctuations in order to effect a reduction in noise, and then flows into the pressure-medium pump FZP. It is pressurized or compressed there by a compressor unit VDE and then flows into the pressure channel DKK of the device DV in order to there likewise again damp the pressure fluctuations or pulsations in the pressure medium owing to the operation of the pump FZP.

The damped pressure medium DM then flows via the outlet opening DA into a pressure-medium supply line DML to a valve (in particular an electropneumatic valve) EPV, which is electrically controllable via a control device STE. In this case, the pressure-medium flow from the pressure-medium supply line DML can be controlled in such a way that the pressure medium is either blocked at the valve EPV or is admitted to the pressure-medium line DL1 or DL2. The pneumatic adjusting arrangement PVA furthermore has a first bladder B1 and a second bladder B2 which are supplied with the pressure medium from the pressure-medium pump FZP via the respective pressure-medium lines DL1 and DL2. In other words, the electropneumatic valve EPV is opened so the pressurized pressure medium DM flows into the bladders B1 and B2 so that the volume of the bladders is increased by the pressure medium. Therefore, if they are arranged as actuating elements in a region of the seat surface or seat back of a vehicle seat FZS, these bladders can alter the corresponding contour of the seat back or seat surface. It is thus possible to achieve static functions, such as a lumbar support, by means of the bladders B1 and B2, or even regular or dynamic functions such as massage functions as a comfort application.

In any case, pressure fluctuations produced in particular through the operation of the pump FZP, and therefore also corresponding noise emissions, are decreased by means of the device DV acting as a damper, namely to a level which is acceptable for the passenger or driver.

Reference is now made to FIG. 4, in which a schematic plan view of a device DV1 for damping pressure fluctuations is shown. In terms of the functional construction with regard to the chambers and channels, the device DV1 here corresponds substantially to the device DV in FIG. 1. Looking more closely at FIG. 4, a base body GK1 of the device DV1 is formed as a circular cylindrical hollow body. The individual intake and expansion chambers AK11, EK11, AK21 and EK21 are arranged around a cylinder axis ZA1 such that they are perpendicular to the cylinder axis ZA1 (which also extends perpendicularly to the plane of the drawing) and, in cross section, each occupy a quarter of the cylinder volume so as to produce the form of (offset) pie slices in cross section. However, other forms or divisions of the base body are also conceivable, for example a clover-leaf form, etc. The partition walls between the chambers can also be curved (as will be further explained with regard to FIG. 5). Parallel delimitations or walls and therefore possible reflections are thereby avoided.

Looking at the flow of pressure medium DM through the device DV1 for damping pressure fluctuations, the pressure medium DM flows along sides of the intake channel ASK of the device DV1, firstly through an inlet opening DE, into the first intake chamber AK11. The pressure medium then arrives in a first expansion chamber EK11 via an overflow channel EE1, wherein pressure fluctuations in the pressure medium DM are damped during the through-flow of the pressure medium from the first intake chamber AK11 through the overflow channel EE1 into the first expansion chamber EK11.

The overflow channel EE1 is formed here by a portion of the partition wall T1 separating the first intake chamber AK11 and the first expansion chamber EK11, wherein this portion of the partition wall has a predetermined spacing from a contact surface AF1 of the base body GK1 on which a cover element (not illustrated) closing all four chambers AK11, EK11, AK21 and EK21 can be positioned. The contact surface AF1 here lies in a plane which is parallel to the plane of the drawing.

The pressure medium flows from the first expansion chamber EK11 via a corresponding pump-side outlet opening DFA to the pressure-medium pump or the compressor thereof.

The pressure medium DM which is pressurized by the pressure-medium pump then flows in a pressure channel DKK via a pump-side pressure-medium inlet opening DFE into the second intake chamber AK21. Owing to the mode of operation of the pressure-medium pump FZP, pressure fluctuations are present in the pressure medium, which should now be damped or prevented by means of a through-flow of the pressure medium through a second overflow channel EE2 into a second expansion chamber EK21. As already explained with regard to the first overflow channel EE1, the second overflow channel EE2 is located accordingly in a portion of a partition wall T2 which separates the second intake chamber AK21 from the second expansion chamber EK21. The said portion of the partition wall T2 is spaced from the contact surface for the cover element (in the direction of the interior of the base body GK1) here, so that, in the assembled state, the overflow channel EE2 is produced between the cover element and the partition wall T2 at the said portion. The expansion of the pressure medium DM from the second intake chamber AK21 into the second expansion chamber EK21 again results in a decrease in the flow speed and therefore in the pressure-medium fluctuation or pulsation in the pressure medium. The pressure medium DM which is damped with regard to the pressure fluctuations in the second expansion chamber EK21 is then discharged from the device DV1 or the second expansion chamber EK21 thereof via a pressure-medium outlet opening DA and supplied for example to a pneumatic adjusting device, as shown in FIG. 3.

To produce pressure-medium-tight chambers AK11, EK11, AK21, EK21 together with the cover element closing the chambers, a sealing element DIE1 is provided on the contact surfaces AF1 of a first outer wall AW1 of the base body, a second outer wall AW2 of the base body GK2 and the partition wall TAD.

Reference is now made to FIG. 5, in which a plan view of a device DV2 for damping pressure fluctuations in a pressure medium DM according to a further embodiment is shown. The device DV2 here again comprises a base body which, in this case, as in FIG. 4, is formed as a circular cylindrical hollow body. The mode of operation of the device DV2 is similar here to that of the device DV1, wherein two expansion chambers are connected downstream of a respective intake chamber both in the intake channel and in the pressure channel. The detailed mode of operation will now be described below.

As can be seen in FIG. 5, pressure medium DM flows here through an inlet opening DE of the device DV2 into a corresponding intake channel ASK2, more precisely firstly into a first intake chamber AK11. The pressure medium then flows through a first overflow channel EE11 in a first partition wall T11 into a first expansion chamber EK11 in order to damp pressure fluctuations in the pressure medium. From the first expansion chamber EK11, the pressure medium then flows via a second overflow channel EE12 of a second partition wall T12 into a second expansion chamber EK12 in order to likewise again further damp the pressure fluctuations in the pressure medium there. The pressure medium which is damped with regard to the pressure fluctuations flows via a pump-side outlet opening DFA to a pressure-medium pump, where it is then pressurized or compressed. The pressurized pressure medium DM then flows via a pump-side pressure-medium inlet opening DFE into the second intake chamber AK21. Owing to the mode of operation of the pressure-medium pump, pressure fluctuations are furthermore present in the pressure medium, which should be damped or prevented by means of a through-flow through a third overflow channel EE21 in a third partition wall T21. The pressure medium which is damped for the first time in the third expansion chamber EK21 then flows via a fourth overflow channel EE22 into a fourth expansion chamber EK22 in order to be further damped there with regard to pressure fluctuations. The expansion of the pressure medium in the respective expansion chambers also results in a decrease again in the flow speed in the pressure channel DKK2 here and therefore in a decrease in the pressure-medium fluctuation or pulsation in the pressure medium.

Finally, the damping medium DM which is damped with regard to the pressure fluctuations flows from the fourth expansion chamber EK22 via a pressure-medium outlet opening DA of the device DV2 and can in turn be supplied for example to a pneumatic adjusting device, as is shown in FIG. 3.

It should be noted that the overflow channels EE11, EE12, EE21 and EE22 of FIG. 5 can be formed according to the overflow channels EE1 and EE2 of FIG. 4, namely through corresponding portions in the partition walls which have a pre-determined spacing from a contact surface of the base body GK2 on which a cover element (not illustrated) is positioned in order to close the corresponding chambers AK11, EK11, EK12, AK21, EK21 and EK22.

A peculiarity of the respective overflow channels is further indicated in FIG. 5. Looking at the pressure-medium flow, for example denoted by the arrow D1, it is apparent here that this strikes the partition wall TAD separating the intake channel ASK2 from the pressure channel DKK2 at an angle W1 of less than 90°. This means that the orientation of the partition wall T12 or the alignment of the corresponding overflow channel EE12 ensures that the flow does not strike a partition wall perpendicularly, but preferably at an angle of less than 90°. This can also be seen in the case of the flow according to the arrow D2, which also strikes an outer wall AW1 of the base body GK2 at an angle W2 of less than 90°. Finally, the flow denoted by the arrow D3 also strikes the partition wall T22 at an angle W3 of less than 90°, and a flow denoted by the arrow D4 strikes an outer wall AW2 of the base body GK2 at an angle W4 of 90° in order to prevent the formation of a turbulent flow and minimize corresponding noise emissions during the expansion.

As already mentioned with regard to 1, in the case of a planar contact surface AF2 and, correspondingly, a planar portion of a cover element to be positioned thereon, adequate leak-tightness of the chambers in the base body GK2 with respect to the environment is enabled in the assembled state of the base body by means of the cover element. A further characteristic of FIG. 5 is that a sealing element DIE2 is now only provided on sides of the pressure channel DKK2, since the pressure medium which is pressurized by the pressure-medium pump is processed or damped here. The sealing element in the form of a rubber or elastomer can again be provided here in a corresponding groove in the base body GK2 or the partition wall TAD or the outer wall AW2 for fixing purposes.

Both for the device DV and the devices DV1 and DV2, a die-cast aluminum or a thermoplastic material (for example in the form of an epoxy resin) can be used for the base body. Materials of this type ensure a precise deformability. Accordingly, a thermoplastic material, but also aluminum oxide, can likewise be used for the cover element. With regard to the sealing elements DIE, DIE1, DIE2 it is possible to provide these in a groove of the base body, as already mentioned, but also in a corresponding groove of the cover element. It is furthermore possible to bond a corresponding elastomer film to the base body or its contact surface or even to the corresponding cover element.

To filter out particles located in the pressure medium taken in, it is advantageous to incorporate a filter element for example in the respective first intake chamber of one of the devices DV, DV1, DV2 in order to bind corresponding particles there to thus prevent a blocking of the overflow channels or of channels in the pneumatic adjusting arrangement connected downstream of a device for damping pressure fluctuations. A single pressure-medium filter with a single filter material can be provided in a corresponding intake chamber here. This can be for example an appropriate foam or a paper filter as a pressure-medium filter. It is furthermore possible to connect two pressure-medium filters, wherein the first pressure-medium filter serves as a coarse-material filter (designed with a foam material) whilst the second filter serves as a fine filter (having, for example, a filter paper element) for also filtering out small particles.

With regard to the device DV2 of FIG. 5, it should be mentioned that little flow noise occurs due to the use of two expansion chambers in a respective pressure-medium channel.

In other words, with the use of a plurality of expansion chambers and overflow channels in a pressure-medium channel (instead of a single expansion chamber and a single flow resistance), the drop in pressure needed for a desired damping is split into several stages. The difference in pressure at the individual overflow channels is thereby smaller, and larger cross sections or throttle cross sections can be used for the individual overflow channels. This in turn results in lower flow speeds and lower noises at the overflow channels acting as throttle points. A high order low-pass filter is thus realized, which exhibits high damping, in particular for pulsation frequencies in the kHz range.

Reference is now made to FIG. 6, in which a device DV0 for damping pressure fluctuations in a pressure medium is shown viewed at an angle from the front and the side. The device DV0 is connected by its left-hand portion shown in FIG. 6 to a pressure-medium pump FZP, for example a vane type compressor. Screws S extend here through a corresponding base body GK0 of the device DV0, which are then brought with a corresponding threaded portion of the pressure-medium pump FZP. The device DV0 here can correspond to the design or the function of one of the devices DV, DV1, DV2. However, it is also generally conceivable that a device DV0 for damping pressure fluctuations only has one pressure-medium channel (intake channel or pressure channel) which is connected to the pressure-medium inlet or pressure-medium outlet of the pressure-medium pump.

It can be advantageous if the front surface of the pressure-medium pump FZP (on which the base body GK0 of the device is mounted) is used in the same way as the cover element of the device DV0, so that it is possible to save on the cover element as an additional part (c.f. also FIG. 1a).

1. A device for damping pressure fluctuations in a pressure medium, comprising:
a base body, and
a cover positioned on a contact surface of a first side of the base body;
the base body and the cover defining an intake chamber,
a boundary of the intake chamber sized and configured to be struck by a pressure medium flow, the boundary comprising an impact surface having a predetermined structure sized and configured to deflect the pressure medium flow.

2. (canceled)

3. (canceled)

4. (canceled)

5. (canceled)

6. The device as claimed in claim 1, further comprising a filter element configured to filter out particles from the pressure medium, wherein the filter element is disposed in the intake chamber.

7. The device as claimed in claim 1, wherein the contact surface of the first side lies in a plane, and wherein the cover has a planar portion which can be brought into contact with the contact surface.

8. The device as claimed in claim 1, in which a sealing element is provided between the cover and the base body a region of the contact surface.

9. (canceled)

10. (canceled)

11. The device as claimed in claim 1, in which the intake chamber has a pressure-medium inlet.

13. (canceled)

14. (canceled)

15. A pressure medium pump for a pneumatic arrangement comprising:
the device for damping pressure fluctuations as claimed in claim 14, wherein a front surface comprised in the pressure medium pump comprises the cover of the device for damping pressure fluctuations.

16. A pneumatic arrangement for adjusting a seat contact-face of a vehicle seat, comprising:
the pressure-medium pump as claimed in claim 15; and
a bladder which can be filled with pressure medium and whereof volume is increased by being filled with pressure medium, and wherein the bladder is filled via an outlet of the pressure-medium pump.
